(19) United States
(12) Patent Application Publication
(10) Pub. No.: US 2018/0331704 A1
(43) Pub. Date: Nov. 15, 2018

(54) RADIO-FREQUENCY CIRCUIT WITH MULTIPLE ANTENNAS ND RADIO-FREQUENCY SIGNAL PROCESSING METHOD

(71) Applicant: ZTE CORPORATION, Guangdong (KR)

(72) Inventor: Weibo XIE, Guangdong (CN)

(21) Appl. No.: 15/774,105

(22) PCT Filed: May 23, 2016
(86) PCT No.: PCT/CN2016/082997

§ 371 Date: May 7, 2018

(30) Foreign Application Priority Data
Nov. 12, 2015 (CN) 201510771868.6

(51) Int. Cl. H04B 1/38; H04B 7/06

(52) U.S. Cl. CPC H04B 1/38; H04B 7/0608

(57) ABSTRACT

The present disclosure provides a radio frequency (RF) circuit with multiple antennas and a RF signal processing method. The RF circuit at least includes: a first antenna and a first RF signal processing circuit connected with each other, and a second antenna and a second RF signal processing circuit connected with each other; a first transceiver connected to the first RF signal processing circuit and the second RF signal processing circuit, configured to output a first frequency-band signal of a first type RF signal to the first RF signal processing circuit, and output a second frequency-band signal of the first type RF signal to the second RF signal processing circuit; and a second transceiver connected to the second RF signal processing circuit, configured to output a second frequency-band signal of a second type RF signal to the second RF signal processing circuit.

### TECHNICAL FIELD

The present disclosure relates to a signal processing technology, and in particular, to a radio-frequency (RF) circuit with multiple antennas and a RF signal processing method.

### BACKGROUND

With development of long term evolution (LTE) technology, wireless terminals are required to support a wider communication bandwidth, which brings a greater challenge to design of antenna. Currently, due to limitations by requirements of cost, size, etc., the fact of having single antenna cannot further widen antenna bandwidth effectively. Thus, multiple antennas are gradually introduced into a design of the wireless terminal, so as to solve a problem of insufficient bandwidth coverage caused by the single antenna.

Emergence of the multiple antennas provides new requirements for a RF circuit of the wireless terminal. Currently, there is merely one transceiver for the multiple antennas, and a circuit with multiple antennas and multiple transceivers has not been implemented.

### SUMMARY

Embodiments of the present disclosure provide a RF circuit with multiple antennas and a RF signal processing method.

The RF circuit with multiple antennas provided by the embodiments of the present disclosure at least includes: a first antenna and a first RF signal processing circuit connected with each other, and a second antenna and a second RF signal processing circuit connected with each other; a first transceiver connected to the first RF signal processing circuit and the second RF signal processing circuit, configured to output a first frequency-band signal of a first type RF signal to the first RF signal processing circuit or receive the first frequency-band signal of the first type RF signal from the first RF signal processing circuit, and output a second frequency-band signal of the first type RF signal to the second RF signal processing circuit or receive the second frequency-band signal of the first type RF signal from the second RF signal processing circuit; and a second transceiver connected to the second RF signal processing circuit, configured to output a second frequency-band signal of a second type RF signal to the second RF signal processing circuit or receive the second frequency-band signal of the second type RF signal from the second RF signal processing circuit.

In some implementations, the RF circuit further includes a first power feedback switch, the first RF signal processing circuit comprises a first coupler, a first antenna switch and a first power amplifier which are connected successively, the second RF signal processing circuit comprises a second coupler, a second antenna switch and a second power amplifier which are connected successively, the first power feedback switch is connected to the first coupler and the second coupler, and is configured to transmit a first coupling signal output from the first coupler to the first transceiver so that the first transceiver adjusts power of the first type RF signal in accordance with the first coupling signal, or transmit a second coupling signal output from the second coupler to the first transceiver or the second transceiver so that the first transceiver or the second transceiver adjusts power of the first type RF signal or the second type RF signal in accordance with the second coupling signal.

In some implementations, the RF circuit further includes a third antenna, a third coupler, a third antenna switch and a third power amplifier which are connected successively, the third power amplifier is connected to the first transceiver and the second transceiver, and is configured to receive a third frequency-band signal of the first type RF signal output from the first transceiver and a third frequency-band signal of the second type RF signal output from the second transceiver.

In some implementations, the RF circuit further includes a second power feedback switch, the second power feedback switch is connected to the first coupler, the second coupler and the third coupler, and is configured to transmit the first coupling signal output from the first coupler to the first transceiver so that the first transceiver adjusts the power of the first type RF signal in accordance with the first coupling signal, or transmit the second coupling signal output from the second coupler to the first transceiver or the second transceiver so that the first transceiver or the second transceiver adjusts the power of the first type RF signal or the second type RF signal in accordance with the second coupling signal, or transmit a third coupling signal output from the third coupler to the first transceiver or the second transceiver so that the first transceiver or the second transceiver adjusts the power of the first type RF signal or the second type RF signal in accordance with the third coupling signal.

In some implementations, the first power amplifier/second power amplifier is configured to amplify power of the first frequency-band signal/second frequency-band signal and then output the first frequency-band signal/second frequency-band signal to the first coupler/second coupler through the first antenna switch/second antenna switch; the first coupler/second coupler is configured to couple a signal output from the first power amplifier/second power amplifier to obtain a first main signal/second main signal and a first coupling signal/second coupling signal, output the first main signal/second main signal to the first antenna/second antenna, and output the first coupling signal/second coupling signal to the power feedback switch; and the first antenna/second antenna is configured to transmit the first main signal/second main signal.

In some implementations, a first transmitting filter is further provided between the first power amplifier and the first antenna switch, and is configured to perform filtering on the first frequency-band signal whose power has been amplified; a second transmitting filter is further provided between the second power amplifier and the second antenna switch, and is configured to perform filtering on the second frequency-band signal whose power has been amplified; a first receiving filter is further provided between the first antenna switch and the first transceiver, and is configured to perform filtering on the first frequency- and signal received through the first antenna, the first coupler and the first antenna switch; a second receiving filter is further provided between the second antenna switch and the first transceiver/second transceiver, and is configured to perform filtering on the second frequency-band signal received through the second antenna, the second coupler and the second antenna switch.

The RF signal processing method provided by the embodiments of the present disclosure is applied to a RF circuit with multiple antennas, and the RF circuit at least includes a first antenna and a first RF signal processing circuit connected with each other, a second antenna and a second RF signal processing circuit connected with each other, a first transceiver and the second transceiver, the method includes: outputting, by the first transceiver, a first frequency-band signal of a first type RF signal to the first RF signal processing circuit or receiving the first frequency-band signal of the first type RF signal from the first RF signal processing circuit, and outputting a second frequency-band signal of the first type RF signal to the second RF signal processing circuit or receiving the second frequency-band signal of the first type RF signal from the second RF signal processing circuit; and outputting, by the second transceiver, a second frequency-band signal of a second type RF signal to the second RF signal processing circuit or receiving the second frequency-band signal of the second type RF signal from the second RF signal processing circuit.

In some implementations, the RF circuit further includes a first power feedback switch, the first RF signal processing circuit includes a first coupler, a first antenna switch and a first power amplifier connected successively, the second RF signal processing circuit includes a second coupler, a second antenna switch and a second power amplifier connected successively, and the method further includes: transmitting, by the first power feedback switch, a first coupling signal output from the first coupler to the first transceiver so that the first transceiver adjusts power of the first type RF signal in accordance with the first coupling signal, or transmitting, by the first power feedback switch, a second coupling signal output from the second coupler to the first transceiver or the second transceiver so that the first transceiver or the second transceiver adjusts power of the first type RF signal or the second type RF signal in accordance with the second coupling signal.

In some implementations, the RF circuit further includes a third antenna, a third coupler, a third antenna switch and a third power amplifier which are connected successively, and correspondingly, the method further includes: receiving, by the third power amplifier, a third frequency-band signal of the first type RF signal output from the first transceiver and a third frequency-band signal of the second type RF signal output from the second transceiver.

In some implementations, the RF circuit further includes a second power feedback switch, and correspondingly, the method further includes: transmitting, by the second power feedback switch, the first coupling signal output from the first coupler to the first transceiver so that the first transceiver adjusts the power of the first type RF signal in accordance with the first coupling signal, or transmitting, by the second power feedback switch, the second coupling signal output from the second coupler to the first transceiver or the second transceiver so that the first transceiver or the second transceiver adjusts the power of the first type RF signal or the second type RF signal in accordance with the second coupling signal, or transmitting, by the second power feedback switch, a third coupling signal output from the third coupler to the first transceiver or the second transceiver so that the first transceiver or the second transceiver adjusts the power of the first type RF signal or the second type RF signal in accordance with the third coupling signal.

In some implementations, the method further includes: amplifying, by the first power amplifier/second power amplifier, power of the first frequency-band signal/second frequency-band signal and then outputting the first frequency-band signal/second frequency-band signal to the first coupler/second coupler through the first antenna switch/second antenna switch; coupling, by the first coupler/second coupler, a signal output from the first power amplifier/second power amplifier to obtain a first main signal/second main signal and a first coupling signal/second coupling signal, outputting the first main signal/second main signal to the first antenna/second antenna, and outputting the first coupling signal/second coupling signal to the power feedback switch; and transmitting, by the first antenna/second antenna, the first main signal/second main signal.

In some implementations, the method further includes: during transmitting signals, performing, by a first transmitting filter, filtering on the first frequency-band signal whose power has been amplified, and performing, by a second transmitting filter, filtering on the second frequency-band signal whose power has been amplified; and during receiving signals, performing, by a first receiving filter, filtering on the first frequency- and signal received through the first antenna, the first coupler and the first antenna switch, and performing, by a second receiving filter, filtering on the second frequency-band signal received through the second antenna, the second coupler and the second antenna switch.

### BRIEF DESCRIPTION OF DRAWINGS

FIG. 1 shows a schematic diagram of structure composition of a RF circuit with multiple antennas in an embodiment of the present disclosure;

FIG. 2 shows a schematic diagram of structure composition of a RF circuit with multiple antennas in an embodiment of the present disclosure;

FIG. 3 shows a schematic diagram of structure composition of a RF circuit with multiple antennas in an embodiment of the present disclosure;

FIG. 4 shows a schematic diagram of structure composition of a RF circuit with multiple antennas in an embodiment of the present disclosure;

FIG. 5 shows a schematic diagram of structure composition of a RF circuit with multiple antennas in an embodiment of the present disclosure;

FIG. 6 shows a schematic diagram of structure composition of a RF circuit with multiple antennas in an embodiment of the present disclosure;

FIG. 7 shows a schematic flow chart of a RF signal processing method in an embodiment of the present disclosure;

FIG. 8 shows a schematic flow chart of a RF signal processing method in an embodiment of the present disclosure; and

FIG. 9 shows a schematic flow chart of a RF signal processing method in an embodiment of the present disclosure.

### DETAILED DESCRIPTION

In order to understand characteristics and technical contents of the embodiments of the present disclosure in detail, embodiments of the present disclosure will be elaborated below in conjunction with accompanying drawings. The accompanying drawings are only for reference purpose, and the present disclosure is not limited thereto.

The embodiments of the present disclosure are directed to a RF circuit with multiple antennas, and the RF circuit includes a plurality of antennas (more than two), a plurality of transceivers (more than two), couplers matching the antennas, switches, power amplifiers and power feedback switches. The antennas are configured to transmit and receive RF signals. The transceivers are configured to modulate and demodulate the RF signals.

In some special medium frequency and low frequency bands, double frequency and combined frequency will affect high frequency band, thus the RF circuit requires an assistant transceiver to process these special frequency bands separately, while the high frequency band is still processed by a main transceiver, so as to avoid an interference by the special frequency bands on the high frequency band.

The RF signals output from the transceivers are input into the corresponding power amplifiers according to frequency bands, and amplified by the power amplifiers, and then entered into the couplers through antenna switches.

After the RF signals pass through the couplers, coupling signals are generated at coupling terminals of the couplers, and the coupling signals are transmitted to the main transceiver and the assistant transceiver respectively through the power feedback switches. Amplitude of the coupling signal is detected by respective detector of each transceiver, and an intensity of the RF signal output currently is determined according to the amplitude of the coupling signal. Power of the output RF signal is adjusted through a closed-loop power control circuit in the transceiver so as to meet requirements for communication with a base station system.

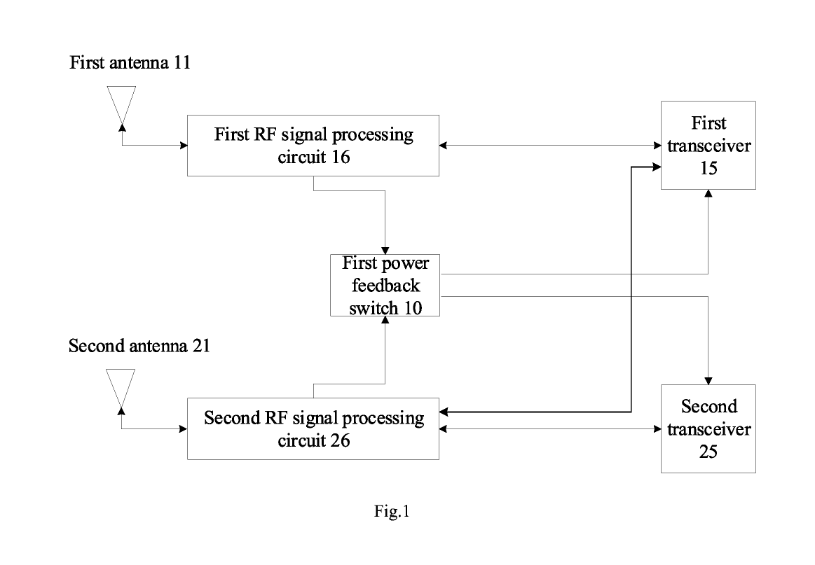

FIG. 1 shows a schematic diagram of structure composition of a RF circuit with multiple antennas in an embodiment of the present disclosure, and as an example, a design of the RF circuit with double antennas will be described below in detail.

As shown in FIG. 1, the RF circuit includes: a first antenna 11 and a first RF signal processing circuit 16 connected with each other, and a second antenna 21 and a second RF signal processing circuit 26 connected with each other; a first transceiver 15 connected to the first RF signal processing circuit 16 and the second RF signal processing circuit 26, configured to output a first frequency-band signal of a first type RF signal to the first RF signal processing circuit 16 or receive the first frequency-band signal of the first type RF signal from the first RF signal processing circuit 16, and output a second frequency-band signal of the first type RF signal to the second RF signal processing circuit 26 or receive the second frequency-band signal of the first type RF signal from the second RF signal processing circuit 26; and a second transceiver 25 connected to the second RF signal processing circuit 26, configured to output a second frequency-band signal of a second type RF signal to the second RF signal processing circuit 26 or receive the second frequency-band signal of the second type RF signal from the second RF signal processing circuit 26.

In some implementations, the RF circuit further includes a first power feedback switch 10, the first power feedback switch 10 is connected to the first RF signal processing circuit 16 and the second RF signal processing circuit 26, and is configured to transmit a first coupling signal output from the first RF signal processing circuit 16 to the first transceiver 15 so that the first transceiver 15 adjusts power of the first type RF signal in accordance with the first coupling signal, or transmit a second coupling signal output from the second RF signal processing circuit 26 to the first transceiver 15 or the second transceiver 25 so that the first transceiver 15 or the second transceiver 25 adjusts power of the first type RF signal or the second type RF signal in accordance with the second coupling signal.

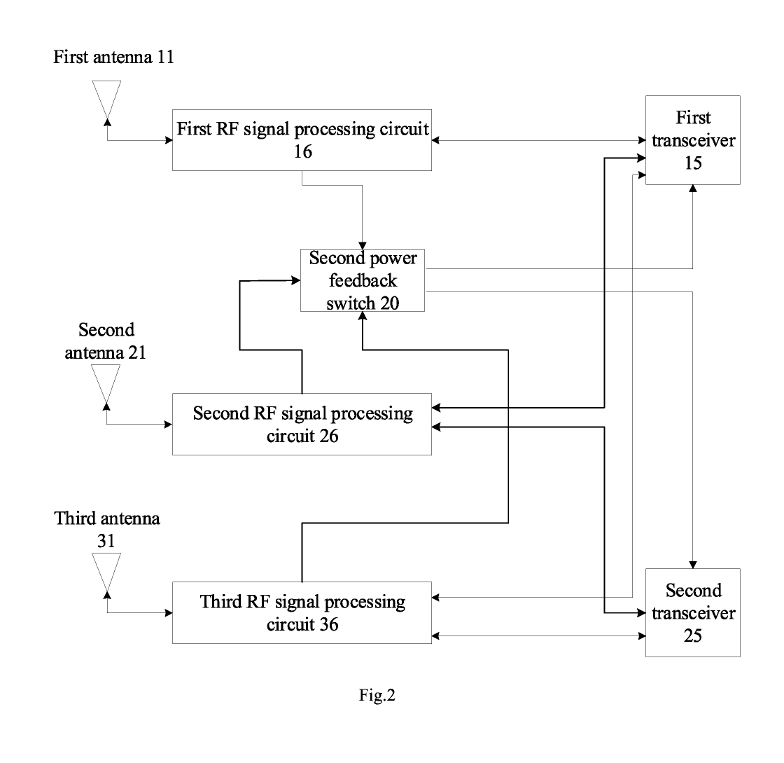

FIG. 2 shows a schematic diagram of structure composition of a RF circuit with multiple antennas in an embodiment of the present disclosure, and as an example, a design of the RF circuit with three antennas will be described below in detail.

As shown in FIG. 2, the RF circuit includes: a first antenna 11 and a first RF signal processing circuit 16 connected with each other, a second antenna 21 and a second RF signal processing circuit 26 connected with each other, and a third antenna 31 and a third RF signal processing circuit 36; a first transceiver 15 connected to the first RF signal processing circuit 16 and the second RF signal processing circuit 26, configured to output a first frequency-band signal of a first type RF signal to the first RF signal processing circuit 16 or receive the first frequency-band signal of the first type RF signal from the first RF signal processing circuit 16, and output a second frequency-band signal of the first type RF signal to the second RF signal processing circuit 26 or receive the second frequency-band signal of the first type RF signal from the second RF signal processing circuit 26; and a second transceiver 25 connected to the second RF signal processing circuit 26, configured to output a second frequency-band signal of a second type RF signal to the second RF signal processing circuit 26 or receive the second frequency-band signal of the second type RF signal from the second RF signal processing circuit 26.

The third RF signal processing circuit 36 is connected to the first transceiver 15 and the second transceiver 25, and is configured to receive a third frequency-band signal of the first type RF signal output from the first transceiver 15 and a third frequency-band signal of the second type RF signal output from the second transceiver 25.

In some implementations, the RF circuit further includes a second power feedback switch 20, and the second power feedback switch 20 is connected to the first RF signal processing circuit 16, the second RF signal processing circuit 26 and the third RF signal processing circuit 36, and is configured to transmit the first coupling signal output from the first RF signal processing circuit 16 to the first transceiver 15 so that the first transceiver 15 adjusts the power of the first type RF signal in accordance with the first coupling signal, or transmit the second coupling signal output from the second RF signal processing circuit 26 to the first transceiver 15 or the second transceiver 25 so that the first transceiver 15 or the second transceiver 25 adjusts the power of the first type RF signal or the second type RF signal in accordance with the second coupling signal, or transmit a third coupling signal output from the third RF signal processing circuit 36 to the first transceiver 15 or the second transceiver 25 so that the first transceiver 15 or the second transceiver 25 adjusts the power of the first type RF signal or the second type RF signal in accordance with the third coupling signal.

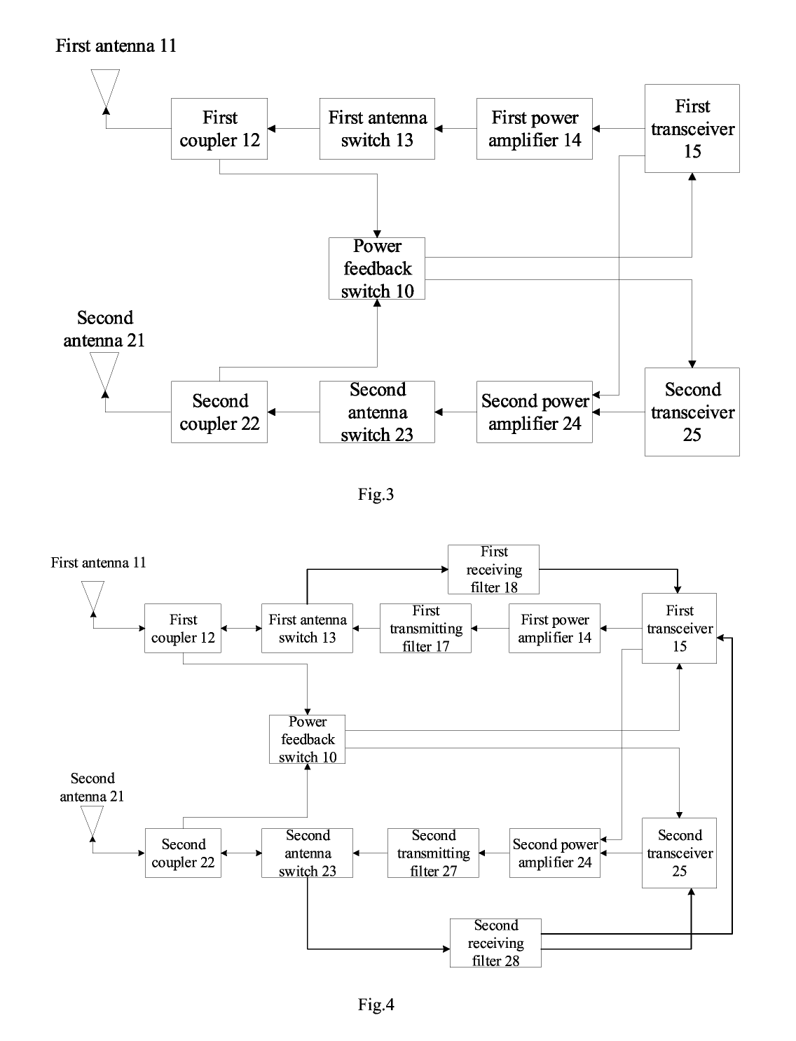

FIG. 3 shows a schematic diagram of structure composition of a RF circuit with multiple antennas in an embodiment of the present disclosure, and as an example, a design of the RF circuit with double antennas will be described below in detail.

As shown in FIG. 3, the RF circuit includes: a first antenna 11, a first coupler 12, a first antenna switch 13 and a first power amplifier 14 which are connected successively, and a second antenna 21, a second coupler 22, a second antenna switch 23 and a second power amplifier 24 which are connected successively; a first transceiver 15 connected to the first power amplifier 14 and the second power amplifier 24, configured to output a first frequency-band signal of a first type RF signal to the first power amplifier 14 and output a second frequency-band signal of the first type RF signal to the second power amplifier 24; and a second transceiver 25 connected to the second power amplifier 24, configured to output a second frequency-band signal of a second type RF signal to the second power amplifier 24. There is an interference between the first type RF signal and the second type RF signal.

In some implementations, the RF circuit further includes a power feedback switch 10, the power feedback switch 10 is connected to the first coupler 12 and the second coupler 22, and is configured to transmit a first coupling signal output from the first coupler 12 to the first transceiver 15 so that the first transceiver 15 adjusts the power of the first type RF signal in accordance with the first coupling signal, or transmit a second coupling signal output from the second coupler 22 to the first transceiver 15 or the second transceiver 25 so that the first transceiver 15 or the second transceiver 25 adjusts the power of the first type RF signal or the second type RF signal in accordance with the second coupling signal.

In some implementations, the first power amplifier 14/second power amplifier 24 is configured to amplify the power of the first frequency-band signal/second frequency-band signal and then output the first frequency-band signal/second frequency-band signal to the first coupler 12/second coupler 22 through the first antenna switch 13/second antenna switch 23; the first coupler 12/second coupler 22 is configured to couple a signal output from the first power amplifier 14/second power amplifier 24 to obtain a first main signal/second main signal and a first coupling signal/second coupling signal, output the first main signal/second main signal to the first antenna 11/second antenna 21, and output the first coupling signal/second coupling signal to the power feedback switch 10; and the first antenna 11/second antenna 21 is configured to transmit the first main signal/second main signal.

In the embodiment, two communication antennas are provided, one antenna operates in a high frequency band, and the other antenna operates in a low frequency band. A complete coverage of operating bands can be achieved by cooperation of the two antennas.

Specifically, the two communication antennas provided in the RF circuit are the first antenna 11 and the second antenna 21, the first antenna 11 operates in the high frequency band, and the second antenna 21 operates in the low frequency band. A complete coverage of operating bands can be achieved by cooperation of the two antennas.

In the embodiment, the RF circuit includes two transceivers, i.e., the first transceiver 15 and the second transceiver 25. The first transceiver 15 which is referred to as a main transceiver can meet requirements for most frequency bands, and is configured to perform modulation or demodulation operations on high frequency signals (first frequency-band signal) and most low frequency signals (second frequency-band signal). Herein, the high frequency signals and the most low frequency signals are collectively referred to as the first type RF signal. The second transceiver 25 is referred to as an assistant transceiver, and is configured to perform modulation and demodulation operations on some special low frequency signals (second frequency-band signal). Herein, the special low frequency signals are referred to as the second type RF signal, such as a frequency doubling signal, a combined frequency signal. The second type RF signal will have influence on the first type RF signal, thus the assistant transceiver is required to separately process the second type RF signal, so as to avoid the interference of the second type RF signal on the first type RF signal. In the embodiment, the RF signals processed by the transceivers refer to communication carrier signals, which are obtained by modulating or demodulating base-band signals of a based-band processor in the transceivers.

In the embodiment, the RF circuit includes two power amplifiers, i.e., the first power amplifier 14 and the second power amplifier 24. The first power amplifier 14 is referred to as a high frequency power amplifier, and is configured to amplify the high frequency signal output from the main transceiver. The second power amplifier 24 is referred to as a low frequency power amplifier, and is configured to amplify the low frequency signal output from the main transceiver and the assistant transceiver. Herein, the main transceiver can further process other low frequency signals (low frequency signals other than the low frequency signals which cause interferences).

In the embodiment, the RF circuit includes two antenna switches, i.e., the first antenna switch 13 and the second antenna switch 23. The first antenna switch 13 is referred to as a high frequency antenna switch, and is configured to switch a connection between a high frequency-band RF path and the first antenna 11. The first antenna switch 13 is controlled by software embedded therein, and selects a corresponding RF path in accordance with logics of the switch. The second antenna 23 is referred to as a low frequency antenna switch, and is configured to switch a connection between a low frequency-band RF path and the second antenna 21. The second antenna switch 23 is controlled by software embedded therein, and selects a corresponding RF path in accordance with logics of the switch.

In the embodiment, the RF circuit includes two couplers, i.e., the first coupler 12 and the second coupler 22. The first coupler 12 which is a high frequency coupler is configured to output a high frequency main signal (referred to as the first main signal) to the first antenna 11, and generate a high frequency coupling signal (referred to as the first coupling signal) for power detecting by coupling. Herein, the high frequency coupling signal is output to the power feedback switch. The second coupler 22 which is referred to as a low frequency coupler is configured to output a low frequency main signal (referred to as the second main signal) to the second antenna 21, and generate a low frequency coupling signal (the second coupling signal) for power detecting by coupling. Herein, the low frequency coupling signal is output to the power feedback switch.

In the embodiment, the RF circuit includes the power feedback switch 10 for connecting a path of the high frequency coupling signal or the low frequency coupling signal to the two transceivers, and enabling that, in a case where a path is connected, other paths are completely isolated from it, so that they will not influence with each other.

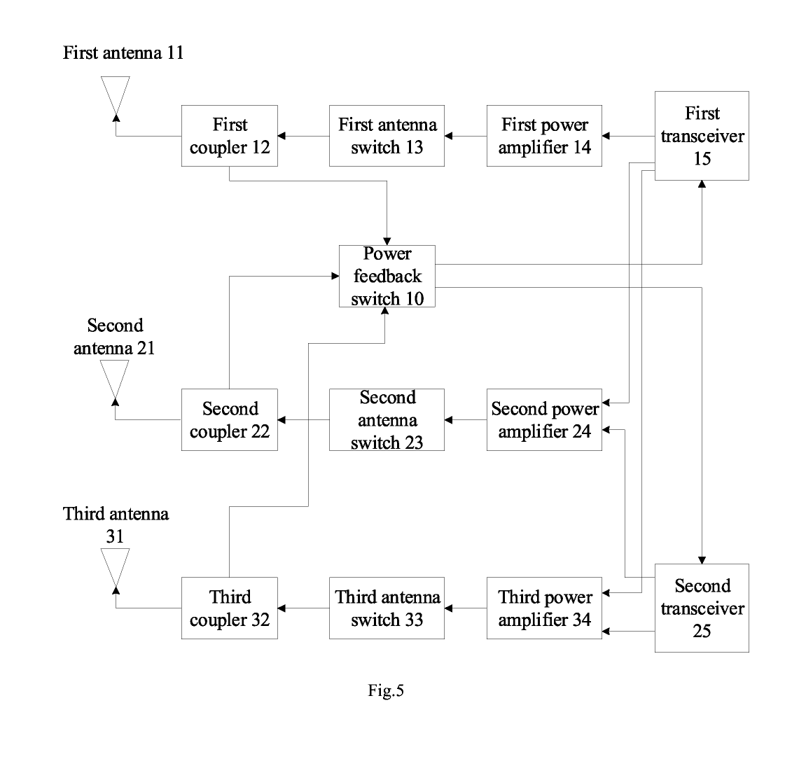

FIG. 4 shows a schematic diagram of structure composition of a RF circuit with multiple antennas in an embodiment of the present disclosure, and as an example, a design of the RF circuit with double antennas will be described below in detail.

As shown in FIG. 4, the RF circuit includes: a first antenna 11, a first coupler 12, a first antenna switch 13 and a first power amplifier 14 which are connected successively, and a second antenna 21, a second coupler 22, a second antenna switch 23 and a second power amplifier 24 which are connected successively; a first transceiver 15 connected to the first power amplifier 14 and the second power amplifier 24, configured to output a first frequency-band signal of a first type RF signal to the first power amplifier 14 and output a second frequency-band signal of the first type RF signal to the second power amplifier 24; and a second transceiver 25 connected to the second power amplifier 24, configured to output a second frequency-band signal of a second type RF signal to the second power amplifier 24. There is an interference between the first type RF signal and the second type RF signal.

In some implementations, the RF circuit further includes a power feedback switch 10, the power feedback switch 10 is connected to the first coupler 12 and the second coupler 22, and is configured to transmit a first coupling signal output from the first coupler 12 to the first transceiver 15 so that the first transceiver 15 adjusts the power of the first type RF signal in accordance with the first coupling signal, or transmit a second coupling signal output from the second coupler 22 to the first transceiver 15 or the second transceiver 25 so that the first transceiver 15 or the second transceiver 25 adjusts the power of the first type RF signal or the second type RF signal in accordance with the second coupling signal.

In some implementations, the first power amplifier 14/second power amplifier 24 is configured to amplify the power of the first frequency-band signal/second frequency-band signal and then output the first frequency-band signal/second frequency-band signal to the first coupler 12/second coupler 22 through the first antenna switch 13/second antenna switch 23; the first coupler 12/second coupler 22 is configured to couple a signal output from the first power amplifier 14/second power amplifier 24 to obtain a first main signal/second main signal and a first coupling signal/second coupling signal, output the first main signal/second main signal to the first antenna 11/second antenna 21, and output the first coupling signal/second coupling signal to the power feedback switch 10; and the first antenna 11/second antenna 21 is configured to transmit the first main signal/second main signal.

In the embodiment, two communication antennas are provided, one antenna operates in a high frequency band, and the other antenna operates in a low frequency band. A complete coverage of operating bands can be achieved by cooperation of the two antennas.

In some implementations, a first transmitting filter 17 is further provided between the first power amplifier 14 and the first antenna switch 13, and is configured to perform filtering on the first frequency-band signal whose power has been amplified; a second transmitting filter 27 is further provided between the second power amplifier 24 and the second antenna switch 23, and is configured to perform filtering on the second frequency-band signal whose power has been amplified; a first receiving filter 18 is further provided between the first antenna switch 13 and the first transceiver 15, and is configured to perform filtering on the first frequency- and signal received through the first antenna 11, the first coupler 12 and the first antenna switch 13; a second receiving filter 28 is further provided between the second antenna switch 23 and the first transceiver 15/second transceiver 25, and is configured to perform filtering on the second frequency-band signal received through the second antenna 21, the second coupler 22 and the second antenna switch 23.

During receiving signals, the first antenna 11 and the second antenna 21 receive signals respectively, and transmit the signals respectively to the corresponding couplers and the antenna switches, the antenna switches then transmit the signals to the receiving filters for filtering, and finally transmit the signals to the transceivers. Herein, most second frequency-band signals can be demodulated by the first transceiver 15, and a few portion of second frequency-band signals (interferences) are demodulated by the second transceiver 25.

FIG. 5 shows a schematic diagram of structure composition of a RF circuit with multiple antennas in an embodiment of the present disclosure, and as an example, a design of the RF circuit with three antennas will be described below in detail.

As shown in FIG. 5, the RF circuit includes: a first antenna 11, a first coupler 12, a first antenna switch 13 and a first power amplifier 14 which are connected successively, and a second antenna 21, a second coupler 22, a second antenna switch 23 and a second power amplifier 24 which are connected successively; a third antenna 31, a third coupler 32, a third antenna switch 33 and a third power amplifier 34 which are connected successively; a first transceiver 15 connected to the first power amplifier 14 and the second power amplifier 24, configured to output a first frequency-band signal of a first type RF signal to the first power amplifier 14 and output a second frequency-band signal of the first type RF signal to the second power amplifier 24; and a second transceiver 25 connected to the second power amplifier 24, configured to output a second frequency-band signal of a second type RF signal to the second power amplifier 24. The third power amplifier 34 is connected to the first transceiver 15 and the second transceiver 25, and is configured to receive a third frequency-band signal of the first type RF signal output from the first transceiver 15 and receive a third frequency-band signal of the second type RF signal output from the second transceiver 25. There is an interference between the first type RF signal and the second type RF signal.

In some implementations, the RF circuit further includes a power feedback switch 10, the power feedback switch 10 is connected to the first coupler 12, the second coupler 22 and the third coupler 32, and is configured to transmit a first coupling signal output from the first coupler 12 to the first transceiver 15 so that the first transceiver 15 adjusts the power of the first type RF signal in accordance with the first coupling signal, or transmit a second coupling signal output from the second coupler 22 to the first transceiver 15 or the second transceiver 25 so that the first transceiver 15 or the second transceiver 25 adjusts the power of the first type RF signal or the second type RF signal in accordance with the second coupling signal, or transmit a third coupling signal output from the third coupler 32 to the first transceiver 15 or the second transceiver 25 so that the first transceiver 15 or the second transceiver 25 adjusts the power of the first type RF signal or the second type RF signal in accordance with the third coupling signal.

In some implementations, the first power amplifier 14/second power amplifier 24/third power amplifier 34 is configured to amplify the power of the first frequency-band signal/second frequency-band signal/third frequency-band signal and then output the first frequency-band signal/second frequency-band signal/third frequency-band signal to the first coupler 12/second coupler 22/third coupler 32 through the first antenna switch 13/second antenna switch 23/third antenna switch 33; the first coupler 12/second coupler 22/third coupler 32 is configured to couple a signal output from the first power amplifier 14/second power amplifier 24/third power amplifier 34 to obtain a first main signal/second main signal/third main signal and the first coupling signal/second coupling signal/third coupling signal, output the first main signal/second main signal/third coupling signal to the first antenna 11/second antenna 21/third antenna 31, and output the first coupling signal/second coupling signal/third coupling signal to the power feedback switch 10; and the first antenna 11/second antenna 21/third antenna 31 is configured to transmit the first main signal/second main signal/third main signal.

In the embodiment, three communication antennas are provided, one antenna operates in a high frequency band, one antenna operates in a medium frequency band, and the other antenna operates in a low frequency band. A complete coverage of operating bands can be achieved by cooperation of the three antennas.

Specifically, the three communication antennas provided in the RF circuit are the first antenna 11, the second antenna 21 and the third antenna 31. The first antenna 11 operates in the high frequency band, the second antenna 21 operates in the medium frequency band, and the third antenna 31 operates in the low frequency band. A complete coverage of operating bands can be achieved by cooperation of the three antennas.

In the embodiment, the RF circuit includes two transceivers, i.e., the first transceiver 15 and the second transceiver 25. The first transceiver 15 which is referred to as a main transceiver can meet requirements for most frequency bands, and is configured to perform modulation or demodulation operations on high frequency signals (first frequency-band signal) and most medium and low frequency signals (second frequency-band signal and third frequency-band signal). Herein, the high frequency signals and the most medium and low frequency signals are collectively referred to as the first type RF signal. The second transceiver 25 is referred to as an assistant transceiver, and is configured to perform modulation and demodulation operations on some special low and medium frequency signals (second frequency-band signal and third frequency-band signal). Herein, the special low and medium frequency signals are referred to as the second type RF signal, such as a frequency doubling signal, a combined frequency signal. The second type RF signal will have influence on the first type RF signal, thus the assistant transceiver is required to separately process the second type RF signal, so as to avoid the interference of the second type RF signal on the first type RF signal. In the embodiment, the RF signals processed by the transceivers refer to communication carrier signals, which are obtained by modulating or demodulating base-band signals of a based-band processor in the transceivers.

In the embodiment, the RF circuit includes three power amplifiers, i.e., the first power amplifier 14, the second power amplifier 24 and the third power amplifier 34. The first power amplifier 14 is referred to as a high frequency power amplifier, and is configured to amplify the high frequency signal output from the main transceiver. The second power amplifier 24 is referred to as a medium frequency power amplifier, and is configured to amplify the medium frequency signal output from the main transceiver and the assistant transceiver. The third power amplifier 34 is referred to as a low frequency power amplifier, and is configured to amplify the low frequency signal output from the main transceiver and the assistant transceiver. Herein, the main transceiver can further process other low and medium frequency signals (low and medium frequency signals other than the low frequency signals which cause interferences).

In the embodiment, the RF circuit includes three antenna switches, i.e., the first antenna switch 13, the second antenna switch 23 and the third antenna switch 33. The first antenna switch 13 is referred to as a high frequency antenna switch, and is configured to switch a connection between a high frequency-band RF path and the first antenna 11. The first antenna switch 13 is controlled by software embedded therein, and selects a corresponding RF path in accordance with logics of the switch. The second antenna 23 is referred to as a medium frequency antenna switch, and is configured to switch a connection between a medium frequency-band RF path and the second antenna 21. The second antenna switch 23 is controlled by software embedded therein, and selects a corresponding RF path in accordance with logics of the switch. The third antenna 33 is referred to as a low frequency antenna switch, and is configured to switch a connection between a low frequency-band RF path and the second antenna 31. The third antenna switch 33 is controlled by software embedded therein, and selects a corresponding RF path in accordance with logics of the switch.

In the embodiment, the RF circuit includes three couplers, i.e., the first coupler 12, the second coupler 22 and the third coupler 32. The first coupler 12 which is a high frequency coupler is configured to output a high frequency main signal (referred to as the first main signal) to the first antenna 11, and generate a high frequency coupling signal (referred to as the first coupling signal) for power detecting by coupling. Herein, the high frequency coupling signal is output to the power feedback switch 10. The second coupler 22 which is referred to as a medium frequency coupler is configured to output a medium frequency main signal (referred to as the second main signal) to the second antenna 21, and generate a medium frequency coupling signal (the second coupling signal) for power detecting by coupling. Herein, the medium frequency coupling signal is output to the power feedback switch 10. The third coupler 32 which is referred to as a low frequency coupler is configured to output a low frequency main signal (referred to as the third main signal) to the third antenna 31, and generate a low frequency coupling signal (the third coupling signal) for power detecting by coupling. Herein, the low frequency coupling signal is output to the power feedback switch 10.

In the embodiment, the RF circuit includes the power feedback switch 10 for connecting a path of the high frequency coupling signal, the medium frequency coupling signal or the low frequency coupling signal to the two transceivers, and enabling that, in a case where a path is connected, other paths are completely isolated from it, so that they will not influence with each other.

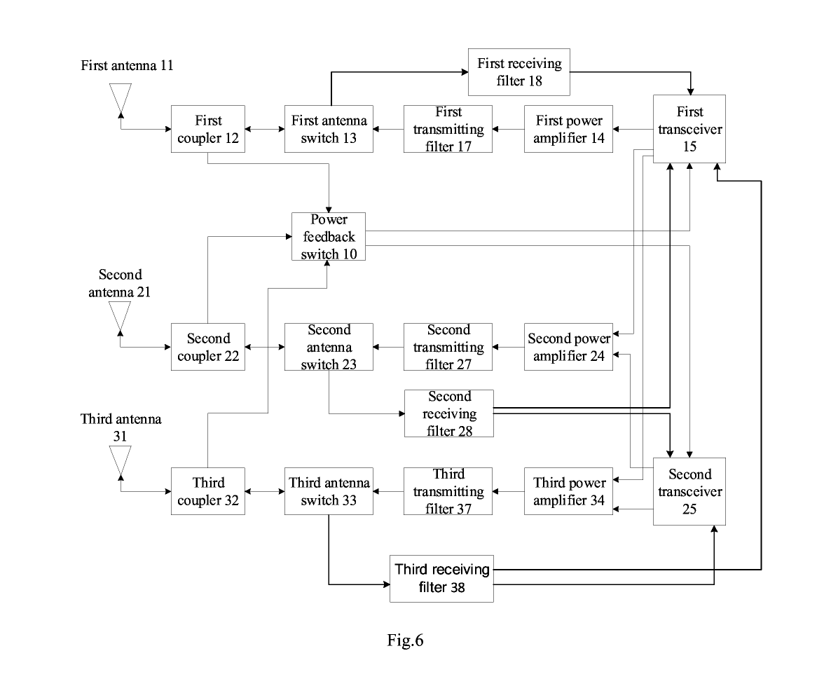

FIG. 6 shows a schematic diagram of structure composition of a RF circuit with multiple antennas in an embodiment of the present disclosure, and as an example, a design of the RF circuit with three antennas will be described below in detail.

As shown in FIG. 6, the RF circuit includes: a first antenna 11, a first coupler 12, a first antenna switch 13 and a first power amplifier 14 which are connected successively, and a second antenna 21, a second coupler 22, a second antenna switch 23 and a second power amplifier 24 which are connected successively; a third antenna 31, a third coupler 32, a third antenna switch 33 and a third power amplifier 34 which are connected successively; a first transceiver 15 connected to the first power amplifier 14 and the second power amplifier 24, configured to output a first frequency-band signal of a first type RF signal to the first power amplifier 14 and output a second frequency-band signal of the first type RF signal to the second power amplifier 24; and a second transceiver 25 connected to the second power amplifier 24, configured to output a second frequency-band signal of a second type RF signal to the second power amplifier 24. The third power amplifier 34 is connected to the first transceiver 15 and the second transceiver 25, and is configured to receive a third frequency-band signal of the first type RF signal output from the first transceiver 15 and receive a third frequency-band signal of the second type RF signal output from the second transceiver 25. There is an interference between the first type RF signal and the second type RF signal.

In some implementations, the RF circuit further includes a power feedback switch 10, the power feedback switch 10 is connected to the first coupler 12, the second coupler 22 and the third coupler 32, and is configured to transmit a first coupling signal output from the first coupler 12 to the first transceiver 15 so that the first transceiver 15 adjusts the power of the first type RF signal in accordance with the first coupling signal, or transmit a second coupling signal output from the second coupler 22 to the first transceiver 15 or the second transceiver 25 so that the first transceiver 15 or the second transceiver 25 adjusts the power of the first type RF signal or the second type RF signal in accordance with the second coupling signal, or transmit a third coupling signal output from the third coupler 32 to the first transceiver 15 or the second transceiver 25 so that the first transceiver 15 or the second transceiver 25 adjusts the power of the first type RF signal or the second type RF signal in accordance with the third coupling signal.

In some implementations, the first power amplifier 14/second power amplifier 24/third power amplifier 34 is configured to amplify the power of the first frequency-band signal/second frequency-band signal/third frequency-band signal and then output the first frequency-band signal/second frequency-band signal/third frequency-band signal to the first coupler 12/second coupler 22/third coupler 32 through the first antenna switch 13/second antenna switch 23/third antenna switch 33; the first coupler 12/second coupler 22/third coupler 32 is configured to couple a signal output from the first power amplifier 14/second power amplifier 24/third power amplifier 34 to obtain a first main signal/second main signal/third main signal and the first coupling signal/second coupling signal/third coupling signal, output the first main signal/second main signal/third coupling signal to the first antenna 11/second antenna 21/third antenna 31, and output the first coupling signal/second coupling signal/third coupling signal to the power feedback switch 10; and the first antenna 11/second antenna 21/third antenna 31 is configured to transmit the first main signal/second main signal/third main signal.

In some implementations, a first transmitting filter 17 is further provided between the first power amplifier 14 and the first antenna switch 13, and is configured to perform filtering on the first frequency-band signal whose power has been amplified; a second transmitting filter 27 is further provided between the second power amplifier 24 and the second antenna switch 23, and is configured to perform filtering on the second frequency-band signal whose power has been amplified; a third transmitting filter 37 is further provided between the third power amplifier 34 and the third antenna switch 33, and is configured to perform filtering on the third frequency-band signal whose power has been amplified; a first receiving filter 18 is further provided between the first antenna switch 13 and the first transceiver 15, and is configured to perform filtering on the first frequency- and signal received through the first antenna 11, the first coupler 12 and the first antenna switch 13; a second receiving filter 28 is further provided between the second antenna switch 23 and the first transceiver 15/second transceiver 25, and is configured to perform filtering on the second frequency-band signal received through the second antenna 21, the second coupler 22 and the second antenna switch 23; a third receiving filter 38 is further provided between the third antenna switch 33 and the first transceiver 15/second transceiver 25, and is configured to perform filtering on the third frequency-band signal received through the third antenna 31, the third coupler 32 and the third antenna switch 33.

During receiving signals, the first antenna 11, the second antenna 21 and the third antenna 31 receive signals respectively, and transmit the signals respectively to the corresponding couplers and the antenna switches, the antenna switches then transmit the signals to the receiving filters for filtering, and finally transmit the signals to the transceivers. Herein, most second frequency-band signals and third frequency-band signals can be demodulated by the first transceiver 15, and a few portion of second frequency-band signals and third frequency-band signals (interferences) are demodulated by the second transceiver 25.

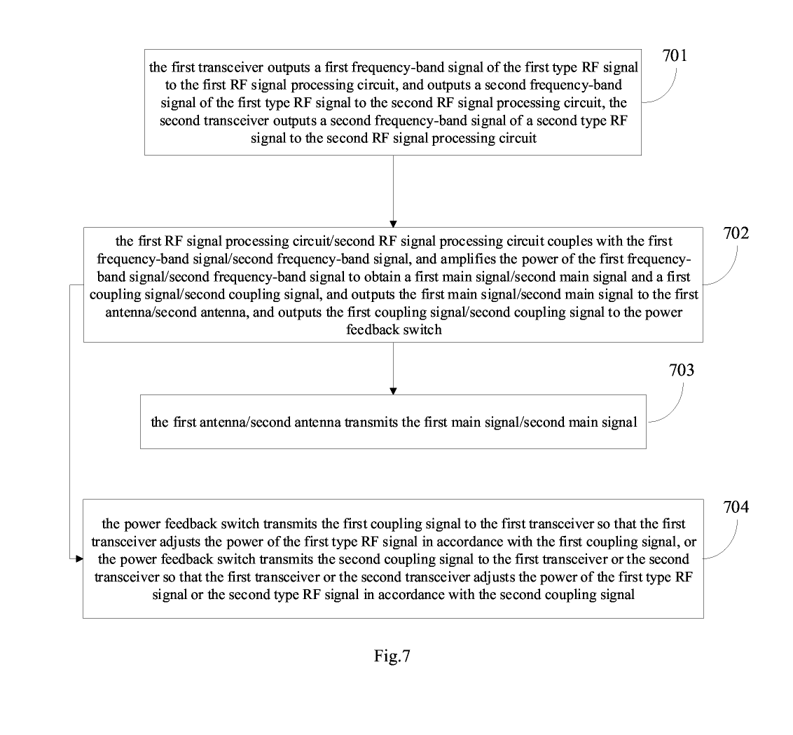

FIG. 7 shows a schematic flow chart of a RF signal processing method in an embodiment of the present disclosure, and the RF signal processing method is applied to a RF circuit with multiple antennas. The RF circuit at least includes a first antenna and a first RF signal processing circuit connected with each other, a second antenna and a second RF signal processing circuit connected with each other, a first transceiver, a second transceiver; and a power feedback switch. As shown in FIG. 7, the RF signal processing method includes following steps S701 through S704.

At step S701, the first transceiver outputs a first frequency-band signal of the first type RF signal to the first RF signal processing circuit, and outputs a second frequency-band signal of the first type RF signal to the second RF signal processing circuit, the second transceiver outputs a second frequency-band signal of a second type RF signal to the second RF signal processing circuit.

There is an interference between the first type RF signal and the second type RF signal. At step S702, the first RF signal processing circuit/second RF signal processing circuit couples with the first frequency-band signal/second frequency-band signal, and amplifies the power of the first frequency-band signal/second frequency-band signal to obtain a first main signal/second main signal and a first coupling signal/second coupling signal, and outputs the first main signal/second main signal to the first antenna/second antenna, and outputs the first coupling signal/second coupling signal to the power feedback switch.

At step S703, the first antenna/second antenna transmits the first main signal/second main signal.

At step S704, the power feedback switch transmits the first coupling signal to the first transceiver so that the first transceiver adjusts the power of the first type RF signal in accordance with the first coupling signal, or the power feedback switch transmits the second coupling signal to the first transceiver or the second transceiver so that the first transceiver or the second transceiver adjusts the power of the first type RF signal or the second type RF signal in accordance with the second coupling signal.

In the embodiment, an example in which two antennas are provided is described, however, it should be understood that, the technical solution of the embodiment can be applied to a case where three or more antennas are provided. For example, in some implementations, the RF circuit further includes a third antenna and a third RF signal processing circuit connected with each other, the third RF signal processing circuit receives a third frequency-band signal of the first type RF signal output from the first transceiver and receives a third frequency-band signal of the second type RF signal output from the second transceiver.

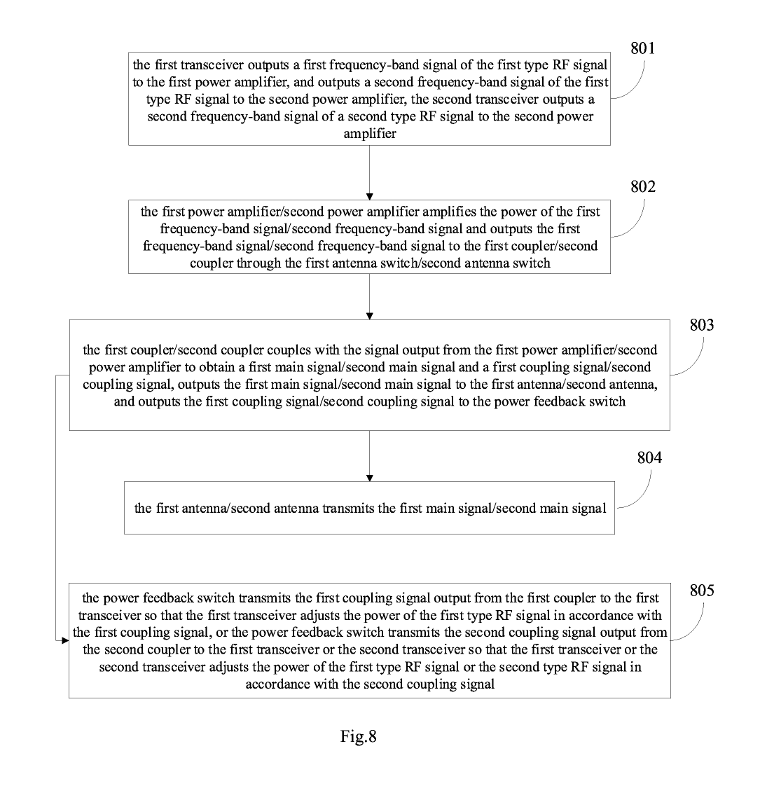

FIG. 8 shows a schematic flow chart of a RF signal processing method in an embodiment of the present disclosure, and the RF signal processing method is applied to a RF circuit with multiple antennas. The RF circuit at least includes: a first antenna, a first coupler, a first antenna switch and a first power amplifier which are connected successively, a second antenna, a second coupler, a second antenna switch and a second power amplifier which are connected successively, a first transceiver, a second transceiver, and a power feedback switch. As shown in FIG. 8, the RF signal processing method includes following steps S801 through S805.

At step S801, the first transceiver outputs a first frequency-band signal of the first type RF signal to the first power amplifier, and outputs a second frequency-band signal of the first type RF signal to the second power amplifier, the second transceiver outputs a second frequency-band signal of a second type RF signal to the second power amplifier.

There is an interference between the first type RF signal and the second type RF signal. At step S802, the first power amplifier/second power amplifier amplifies the power of the first frequency-band signal/second frequency-band signal and outputs the first frequency-band signal/second frequency-band signal to the first coupler/second coupler through the first antenna switch/second antenna switch.

At step S803, the first coupler/second coupler couples with the signal output from the first power amplifier/second power amplifier to obtain a first main signal/second main signal and a first coupling signal/second coupling signal, outputs the first main signal/second main signal to the first antenna/second antenna, and outputs the first coupling signal/second coupling signal to the power feedback switch.

At step S804, the first antenna/second antenna transmits the first main signal/second main signal.

At step S805, the power feedback switch transmits the first coupling signal output from the first coupler to the first transceiver so that the first transceiver adjusts the power of the first type RF signal in accordance with the first coupling signal, or the power feedback switch transmits the second coupling signal output from the second coupler to the first transceiver or the second transceiver so that the first transceiver or the second transceiver adjusts the power of the first type RF signal or the second type RF signal in accordance with the second coupling signal.

In the embodiment, an example in which two antennas are provided is described, however, it should be understood that, the technical solution of the embodiment can be applied to a case where three or more antennas are provided. For example, in some implementations, the RF circuit further includes a third antenna, a third coupler, a third antenna switch and a third power amplifier which are connected successively, the third power amplifier receives a third frequency-band signal of the first type RF signal output from the first transceiver and receives a third frequency-band signal of the second type RF signal output from the second transceiver.

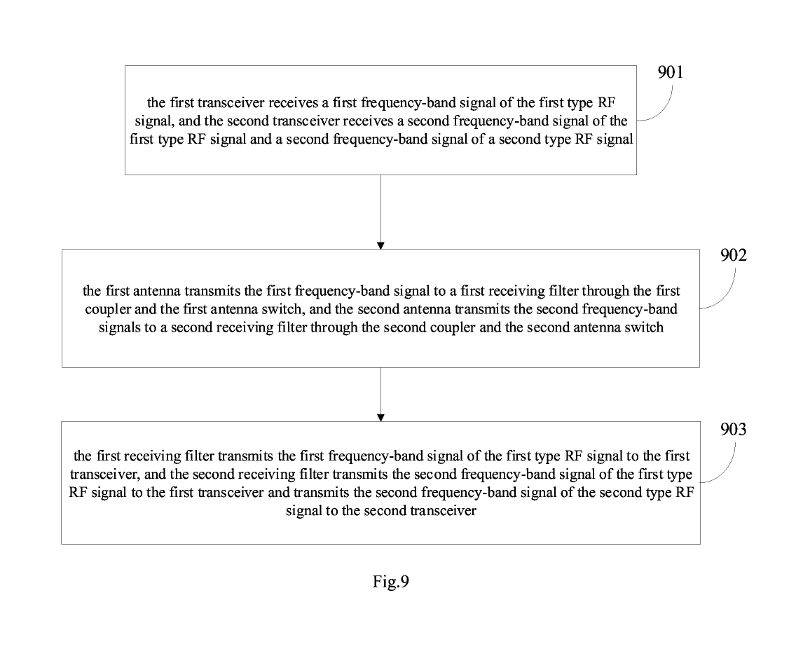

FIG. 9 shows a schematic flow chart of a RF signal processing method in an embodiment of the present disclosure, and the RF signal processing method is applied to a RF circuit with multiple antennas. The RF circuit at least includes a first antenna and a first RF signal processing circuit connected with each other, a second antenna and a second RF signal processing circuit connected with each other, a first transceiver, a second transceiver; and a power feedback switch. As shown in FIG. 9, the RF signal processing method includes following steps S901 through S903.

At step S901, the first transceiver receives a first frequency-band signal of the first type RF signal, and the second transceiver receives a second frequency-band signal of the first type RF signal and a second frequency-band signal of a second type RF signal.

At step S902, the first antenna transmits the first frequency-band signal to a first receiving filter through the first coupler and the first antenna switch, and the second antenna transmits the second frequency-band signals to a second receiving filter through the second coupler and the second antenna switch.

At step S903, the first receiving filter transmits the first frequency-band signal of the first type RF signal to the first transceiver, and the second receiving filter transmits the second frequency-band signal of the first type RF signal to the first transceiver and transmits the second frequency-band signal of the second type RF signal to the second transceiver.

There is an interference between the first type RF signal and the second type RF signal. In the embodiment, an example in which two antennas are provided is described, however, it should be understood that, the technical solution of the embodiment can be applied to a case where three or more antennas are provided. For example, in some implementations, the RF circuit further includes a third antenna and a third RF signal processing circuit connected with each other.

The RF signal processing method will be further described below in detail in conjunction with specific scenes.

In an example in which two antennas are provided, an operation process for the high frequency band includes: a high frequency signal is output from the main transceiver and amplified by a high frequency power amplifier; the amplified high frequency signal is connected to a high frequency coupler through a high frequency antenna switch, the high frequency antenna switch connects different high frequency-band hardware paths with the high frequency coupler; the high frequency signal transmitted to the high frequency coupler are divided into two signals, i.e., a main signal and a high frequency coupling signal, the main signal is output to a high frequency antenna through the high frequency coupler, and the high frequency coupling signal is output from a coupling terminal of the high frequency coupler and transmitted to the main transceiver through a power feedback switch; a detector inside the main transceiver detects a high frequency feedback signal, determines an intensity of the current RF signal in accordance with the high frequency feedback signal, adjusts the power of the high frequency RF signal and dynamically controls the high frequency RF signal, so that the high frequency RF signal meets requirements for communication with a base station system.

An operation process for the low frequency band includes: a low frequency signal is output from the main transceiver and the assistant transceiver, and amplified by a low frequency power amplifier; the amplified low frequency signal is connected to a low frequency coupler through a low frequency antenna switch, the low frequency antenna switch connects different low frequency-band hardware paths with the low frequency coupler; the low frequency signal transmitted to the low frequency coupler are divided into two signals, i.e., a main signal and a low frequency coupling signal, the main signal is output to a low frequency antenna through the low frequency coupler, and the low frequency coupling signal is output from a coupling terminal of the low frequency coupler and transmitted to the main transceiver through a power feedback switch; a detector inside the main transceiver detects a low frequency feedback signal, determines an intensity of the current RF signal in accordance with the low frequency feedback signal, adjusts the power of the low frequency RF signal and dynamically controls the low frequency RF signal, so that the low frequency RF signal meets requirements for communication with a base station system.

In an example in which three antennas are provided, an operation process for the high frequency band includes: a high frequency signal is output from a main transceiver and amplified by a high frequency power amplifier; the amplified high frequency signal is connected to a high frequency coupler through a high frequency antenna switch, the high frequency antenna switch connects different high frequency-band hardware paths with the high frequency coupler; the high frequency signal transmitted to the high frequency coupler are divided into two signals, i.e., a main signal and a high frequency coupling signal, the main signal is output to the high frequency antenna through the high frequency coupler, and the high frequency coupling signal is output from a coupling terminal of the high frequency coupler and transmitted to the main transceiver through a power feedback switch; a detector inside the main transceiver detects a high frequency feedback signal, determines an intensity of the current RF signal in accordance with the high frequency feedback signal, adjusts the power of the high frequency RF signal and dynamically controls the high frequency RF signal, so that the high frequency RF signal meets requirements for communication with a base station system.

An operation process for the medium frequency band includes: a medium frequency signal is output from the main transceiver, and amplified by a medium frequency power amplifier; the amplified medium frequency signal is connected to a medium frequency coupler through a medium frequency antenna switch, the medium frequency antenna switch connects different medium frequency-band hardware paths with the medium frequency coupler; the medium frequency signal transmitted to the medium frequency coupler are divided into two signals, i.e., a main signal and medium frequency coupling signal, the main signal is output to a medium frequency antenna through the medium frequency coupler, and the medium frequency coupling signal is output from a coupling terminal of the medium frequency coupler and transmitted to the main transceiver through a power feedback switch; a detector inside the main transceiver detects a medium frequency feedback signal, determines an intensity of the current RF signal in accordance with the medium frequency feedback signal, adjusts the power of the medium frequency RF signal and dynamically controls the medium frequency RF signal, so that the medium frequency RF signal meets requirements for communication with a base station system.

An operation process for the low frequency band includes: a low frequency signal is output from a main transceiver and an assistant transceiver, and amplified by a low frequency power amplifier; the amplified low frequency signal is connected to a low frequency coupler through a low frequency antenna switch, the low frequency antenna switch connects different low frequency-band hardware paths with the low frequency coupler; the low frequency signal transmitted to the low frequency coupler are divided into two signals, i.e., a main signal and a low frequency coupling signal, the main signal is output to a low frequency antenna through the low frequency coupler, and the low frequency coupling signal is output from a coupling terminal of the low frequency coupler and transmitted to the main transceiver through a power feedback switch; a detector inside the main transceiver detects a low frequency feedback signal, determines an intensity of the current RF signal in accordance with the low frequency feedback signal, adjusts the power of the low frequency RF signal and dynamically controls the low frequency RF signal, so that the low frequency RF signal meets requirements for communication with a base station system.

It should be understood that, the method and the circuit disclosed in embodiments of the present disclosure can also be implemented by other ways. The examples described above are merely for illustration. For example, the division of units/components is merely a logic function division, and an implementation can be achieved by other divisions. For example, multiple units or components can be combined or integrated into another system, or some characteristics can be ignored or not performed. In addition, direct or indirect couplings, or communication connections among components shown and discussed above can be achieved by some interfaces, and the couplings or communication connections can be electrical, mechanical or in other forms.

Units/components which are illustrated separately above can be physically separated or not physically separated, units/components illustrated can be physical units/components or not physical units/components, that is, they can be located in a place or distributed over multiple network units, and all or a portion of the units/components can be selected for implementing solutions of the present disclosure as required.

Moreover, function units/components in embodiments of the present disclosure can be integrated into one processing unit or separated from each other, or two or more of the function units/components can be integrated into one unit. The integrated unit described above can be implemented by hardware or a combination of hardware and software.

Specific implementations are described above, but the protection scope of the present disclosure is not limited thereto. People with ordinary skill in the art can make various variants or substitutes easily without departing from the scope of the present disclosure, and any of these variants or substitutes should fall into the scope of the present disclosure.

### INDUSTRIAL APPLICABILITY

In technical solutions of the present disclosure, the RF circuit with multiple antennas at least includes: the first antenna and the first RF signal processing circuit connected with each other; the second antenna and the second RF signal processing circuit connected with each other; a first transceiver connected with the first RF signal processing circuit and the second RF signal processing circuit; and a second transceiver connected with the second RF signal processing circuit. In the design of the wireless terminal, a circuit design with dual antennas or even more antennas is realized by the RF circuit, and the problem of insufficient bandwidth coverage caused by the single antenna is solved, and also, a problem of mutual interference among frequency bands in a state of multiple frequency bands being coexist with each other is solved.

1. A radio frequency (RF) circuit with multiple antennas, at least comprising:
a first antenna and a first RF signal processing circuit connected with each other, and a second antenna and a second RF signal processing circuit connected with each other;
a first transceiver connected to the first RF signal processing circuit and the second RF signal processing circuit, configured to output a first frequency-band signal of a first type RF signal to the first RF signal processing circuit or receive the first frequency-band signal of the first type RF signal from the first RF signal processing circuit, and output a second frequency-band signal of the first type RF signal to the second RF signal processing circuit or receive the second frequency-band signal of the first type RF signal from the second RF signal processing circuit; and
a second transceiver connected to the second RF signal processing circuit, configured to output a second frequency-band signal of a second type RF signal to the second RF signal processing circuit or receive the second frequency-band signal of the second type RF signal from the second RF signal processing circuit.

2. The RF circuit of claim 1, further comprising a first power feedback switch, wherein the first RF signal processing circuit comprises a first coupler, a first antenna switch and a first power amplifier which are connected successively, the second RF signal processing circuit comprises a second coupler, a second antenna switch and a second power amplifier which are connected successively,
the first power feedback switch is connected to the first coupler and the second coupler, and is configured to transmit a first coupling signal output from the first coupler to the first transceiver so that the first transceiver adjusts power of the first type RF signal in accordance with the first coupling signal, or transmit a second coupling signal output from the second coupler to the first transceiver or the second transceiver so that the first transceiver or the second transceiver adjusts power of the first type RF signal or the second type RF signal in accordance with the second coupling signal.

3. The RF circuit of claim 1, further comprising a third antenna, a third coupler, a third antenna switch and a third power amplifier which are connected successively,
the third power amplifier is connected to the first transceiver and the second transceiver, and is configured to receive a third frequency-band signal of the first type RF signal output from the first transceiver and a third frequency-band signal of the second type RF signal output from the second transceiver.

4. The RF circuit of claim 3, further comprising a second power feedback switch, the second power feedback switch is connected to the first coupler, the second coupler and the third coupler, and is configured to transmit the first coupling signal output from the first coupler to the first transceiver so that the first transceiver adjusts the power of the first type RF signal in accordance with the first coupling signal, or transmit the second coupling signal output from the second coupler to the first transceiver or the second transceiver so that the first transceiver or the second transceiver adjusts the power of the first type RF signal or the second type RF signal in accordance with the second coupling signal, or transmit a third coupling signal output from the third coupler to the first transceiver or the second transceiver so that the first transceiver or the second transceiver adjusts the power of the first type RF signal or the second type RF signal in accordance with the third coupling signal.

5. The RF circuit of claim 2, wherein the first power amplifier/second power amplifier is configured to amplify power of the first frequency-band signal/second frequency-band signal and then output the first frequency-band signal/second frequency-band signal to the first coupler/second coupler through the first antenna switch/second antenna switch;
the first coupler/second coupler is configured to couple a signal output from the first power amplifier/second power amplifier to obtain a first main signal/second main signal and a first coupling signal/second coupling signal, output the first main signal/second main signal to the first antenna/second antenna, and output the first coupling signal/second coupling signal to the power feedback switch; and
the first antenna/second antenna is configured to transmit the first main signal/second main signal.

6. The RF circuit of claim 2, wherein a first transmitting filter is further provided between the first power amplifier and the first antenna switch, and is configured to perform filtering on the first frequency-band signal whose power has been amplified; a second transmitting filter is further provided between the second power amplifier and the second antenna switch, and is configured to perform filtering on the second frequency-band signal whose power has been amplified;
a first receiving filter is further provided between the first antenna switch and the first transceiver, and is configured to perform filtering on the first frequency- and signal received through the first antenna, the first coupler and the first antenna switch; a second receiving filter is further provided between the second antenna switch and the first transceiver/second transceiver, and is configured to perform filtering on the second frequency-band signal received through the second antenna, the second coupler and the second antenna switch.

7. A radio frequency (RF) signal processing method applied to a RF circuit with multiple antennas, the RF circuit at least comprises a first antenna and a first RF signal processing circuit connected with each other, a second antenna and a second RF signal processing circuit connected with each other, a first transceiver and a second transceiver, the method comprising:
outputting, by the first transceiver, a first frequency-band signal of a first type RF signal to the first RF signal processing circuit or receiving the first frequency-band signal of the first type RF signal from the first RF signal processing circuit, and outputting a second frequency-band signal of the first type RF signal to the second RF signal processing circuit or receiving the second frequency-band signal of the first type RF signal from the second RF signal processing circuit; and
outputting, by the second transceiver, a second frequency-band signal of a second type RF signal to the second RF signal processing circuit or receiving the second frequency-band signal of the second type RF signal from the second RF signal processing circuit.

8. The RF signal processing method of claim 7, wherein the RF circuit further comprises a first power feedback switch, the first RF signal processing circuit comprises a first coupler, a first antenna switch and a first power amplifier connected successively, the second RF signal processing circuit comprises a second coupler, a second antenna switch and a second power amplifier connected successively, and the method further comprising:
transmitting, by the first power feedback switch, a first coupling signal output from the first coupler to the first transceiver so that the first transceiver adjusts power of the first type RF signal in accordance with the first coupling signal, or
transmitting, by the first power feedback switch, a second coupling signal output from the second coupler to the first transceiver or the second transceiver so that the first transceiver or the second transceiver adjusts power of the first type RF signal or the second type RF signal in accordance with the second coupling signal.

9. The RF signal processing method of claim 7, wherein the RF circuit further comprises a third antenna, a third coupler, a third antenna switch and a third power amplifier which are connected successively, and correspondingly, the method further comprising:
receiving, by the third power amplifier, a third frequency-band signal of the first type RF signal output from the first transceiver and a third frequency-band signal of the second type RF signal output from the second transceiver.

10. The RF signal processing method of claim 9, wherein the RF circuit further comprises a second power feedback switch, and correspondingly, the method further comprising:
transmitting, by the second power feedback switch, the first coupling signal output from the first coupler to the first transceiver so that the first transceiver adjusts the power of the first type RF signal in accordance with the first coupling signal, or
transmitting, by the second power feedback switch, the second coupling signal output from the second coupler to the first transceiver or the second transceiver so that the first transceiver or the second transceiver adjusts the power of the first type RF signal or the second type RF signal in accordance with the second coupling signal, or
transmitting, by the second power feedback switch, a third coupling signal output from the third coupler to the first transceiver or the second transceiver so that the first transceiver or the second transceiver adjusts the power of the first type RF signal or the second type RF signal in accordance with the third coupling signal.

11. The RF signal processing method of claim 8, further comprising:
amplifying, by the first power amplifier/second power amplifier, power of the first frequency-band signal/second frequency-band signal and then outputting the first frequency-band signal/second frequency-band signal to the first coupler/second coupler through the first antenna switch/second antenna switch;
coupling, by the first coupler/second coupler, a signal output from the first power amplifier/second power amplifier to obtain a first main signal/second main signal and a first coupling signal/second coupling signal, outputting the first main signal/second main signal to the first antenna/second antenna, and outputting the first coupling signal/second coupling signal to the power feedback switch; and
transmitting, by the first antenna/second antenna, the first main signal/second main signal.

12. The RF signal processing method of claim 8, further comprising:
During transmitting signals, performing, by a first transmitting filter, filtering on the first frequency-band signal whose power has been amplified, and performing, by a second transmitting filter, filtering on the second frequency-band signal whose power has been amplified;
During receiving signals, performing, by a first receiving filter, filtering on the first frequency- and signal received through the first antenna, the first coupler and the first antenna switch, and performing, by a second receiving filter, filtering on the second frequency-band signal received through the second antenna, the second coupler and the second antenna switch.

13. The RF circuit of claim 4, wherein the first power amplifier/second power amplifier is configured to amplify power of the first frequency-band signal/second frequency-band signal and then output the first frequency-band signal/second frequency-band signal to the first coupler/second coupler through the first antenna switch/second antenna switch;
the first coupler/second coupler is configured to couple a signal output from the first power amplifier/second power amplifier to obtain a first main signal/second main signal and a first coupling signal/second coupling signal, output the first main signal/second main signal to the first antenna/second antenna, and output the first coupling signal/second coupling signal to the power feedback switch; and
the first antenna/second antenna is configured to transmit the first main signal/second main signal.

14. The RF circuit of claim 4, wherein a first transmitting filter is further provided between the first power amplifier and the first antenna switch, and is configured to perform filtering on the first frequency-band signal whose power has been amplified; a second transmitting filter is further provided between the second power amplifier and the second antenna switch, and is configured to perform filtering on the second frequency-band signal whose power has been amplified;
a first receiving filter is further provided between the first antenna switch and the first transceiver, and is configured to perform filtering on the first frequency- and signal received through the first antenna, the first coupler and the first antenna switch; a second receiving filter is further provided between the second antenna switch and the first transceiver/second transceiver, and is configured to perform filtering on the second frequency-band signal received through the second antenna, the second coupler and the second antenna switch.

15. The RF signal processing method of claim 10, further comprising:
amplifying, by the first power amplifier/second power amplifier, power of the first frequency-band signal/second frequency-band signal and then outputting the first frequency-band signal/second frequency-band signal to the first coupler/second coupler through the first antenna switch/second antenna switch;
coupling, by the first coupler/second coupler, a signal output from the first power amplifier/second power amplifier to obtain a first main signal/second main signal and a first coupling signal/second coupling signal, outputting the first main signal/second main signal to the first antenna/second antenna, and outputting the first coupling signal/second coupling signal to the power feedback switch; and
transmitting, by the first antenna/second antenna, the first main signal/second main signal.

16. The RF signal processing method of claim 10, further comprising:
During transmitting signals, performing, by a first transmitting filter, filtering on the first frequency-band signal whose power has been amplified, and performing, by a second transmitting filter, filtering on the second frequency-band signal whose power has been amplified;
During receiving signals, performing, by a first receiving filter, filtering on the first frequency- and signal received through the first antenna, the first coupler and the first antenna switch, and performing, by a second receiving filter, filtering on the second frequency-band signal received through the second antenna, the second coupler and the second antenna switch.
